(19) United States
(12) Patent Application Publication
(10) Pub. No.: US 2024/0214485 A1
(43) Pub. Date: Jun. 27, 2024

(54) INFORMATION PROCESSING SYSTEM, INFORMATION PROCESSING METHOD, AND PROGRAM

(71) Applicant: GREE, INC., Tokyo (JP)

(72) Inventor: Akihiko SHIRAI, Kanagawa (JP)

(73) Assignee: GREE, INC., Tokyo (JP)

(21) Appl. No.: 18/214,927

(22) Filed: Jun. 27, 2023

(30) Foreign Application Priority Data
Dec. 21, 2022 (JP) 2022-204711
Apr. 13, 2023 (JP) 2023-065636

(51) Int. Cl. H04M 1/72436; G06F 3/04815; G06F 3/0482; H04W 4/14

(52) U.S. Cl. CPC H04M 1/72436; G06F 3/04815; G06F 3/0482; H04W 4/14

(57) ABSTRACT

An information processing system performs information processing related to chat-type communication among a plurality of users The system includes one or more processors programmed to acquire sent content that is sent from a first user in a chat, and generate a plurality of options related to reply content from a second user with respect to the sent content. The plurality of options includes a first option associated with a destination in a virtual space displayed via an electronic device of the second user. The destination is determined based on the sent content.

This application claims the benefit of priority from Japanese Patent Application No. 2022-204711 filed Dec. 21, 2022, and Japanese Patent Application No. 2023-065636 filed Apr. 13, 2023, the entire contents of the prior applications being incorporated herein by reference.

### TECHNICAL FIELD

This disclosure relates to an information processing system, an information processing method, and a program.

### BACKGROUND TECHNOLOGY

A technology is known in which (i) a text message that contains information that can be displayed as a character image is generated at a sending-side mobile device and is transmitted, and the received text message is analyzed at a receiving side; and (ii) thereafter, when information for displaying the character image is included, the text message is visually displayed together with the corresponding character image.

### SUMMARY

### Problems to be Resolved

However, in the above-described conventional technology, it is difficult to support chat-type communication among users with a relative low processing load.

Therefore, in one aspect, an object of this disclosure is to reduce a processing load related to chat-type communication among users.

In one aspect, an information processing system is provided, which performs information processing related to chat-type communicating among a plurality of users. The information processing system comprises:
an acquisition portion that acquires sent content that is sent from a sending side; and
an option generator that generates a plurality of options related to reply content from a receiving side with respect to the sent content, wherein:
the plurality of options includes a first option associated with a destination in a virtual space that can be viewed via an electronic device; and
the destination in one chat is determined based on the sent content.

### Effects

In one aspect, according to this disclosure, it is possible to reduce a processing load related to chat-type communication among users.

### BRIEF DESCRIPTION OF DRAWINGS

FIG. 1 is a block diagram of a chat-related support system according to this embodiment.

FIG. 1A is a block diagram of a processing circuit that executes a computer-based operation according to this disclosure.

FIG. 2 is an explanatory diagram of a terminal image that can be viewed via a head-mounted display.

FIG. 3 is an explanatory diagram of a terminal image that can be viewed via a smartphone.

FIG. 4 is an explanatory diagram of various access methods with respect to a metaverse space.

FIG. 5 is a diagram showing an example of a time series of devices used from 0:00 to 24:00 for a particular one user.

FIG. 5A is a diagram showing an example of a time series of user states and devices used.

FIG. 6 is a diagram (part 1) conceptually showing how a plurality of options are presented regarding reply content from each of other users with respect to sent content from one user.

FIG. 7 is a diagram (part 2) conceptually showing how a plurality of options are presented regarding reply content from each of other users with respect to sent content from one user.

FIG. 8 is an explanatory diagram of movement-related processing, and is an explanatory diagram (part 1) related to a plurality of options.

FIG. 9 is an explanatory diagram of movement-related processing, and is an explanatory diagram (part 2) related to a plurality of options.

FIG. 10 is an example of a functional block diagram of a server device related to an option-related function.

FIG. 11 is an explanatory diagram of data in a user information memory.

FIG. 12 is an explanatory diagram of data in an avatar information memory.

FIG. 13 is an example of a functional block diagram of one terminal device related to the option-related function.

### MODES TO IMPLEMENT EMBODIMENTS

Hereinafter, various embodiments will be described with reference to the drawings. In the attached drawings, for ease of viewing, only a portion of a plurality of parts having the same attribute may be given reference numerals.

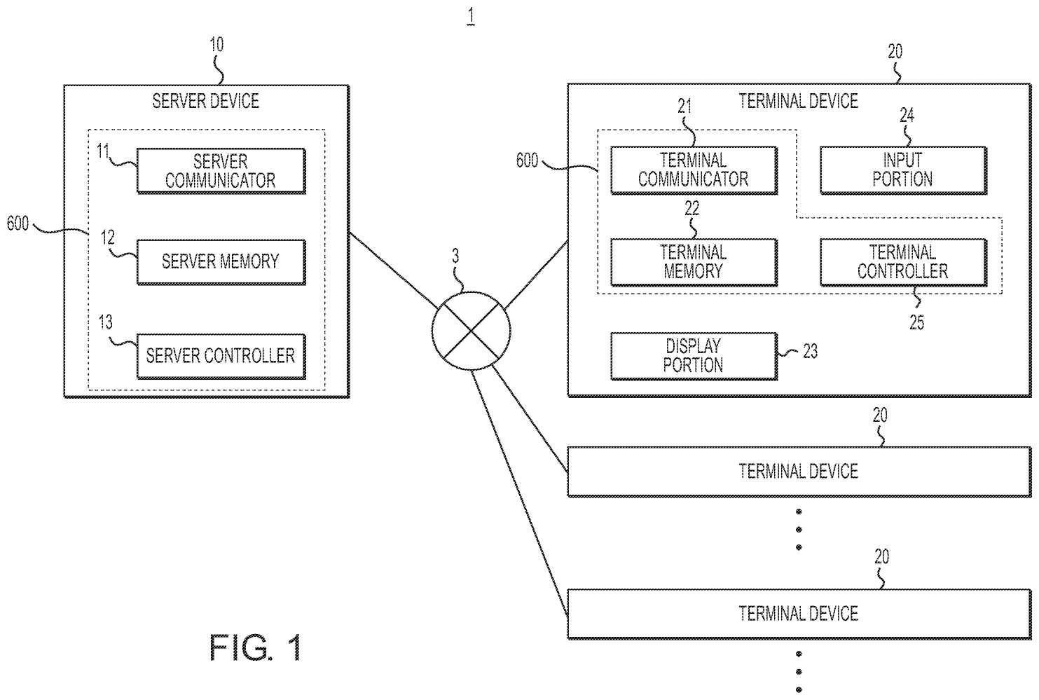

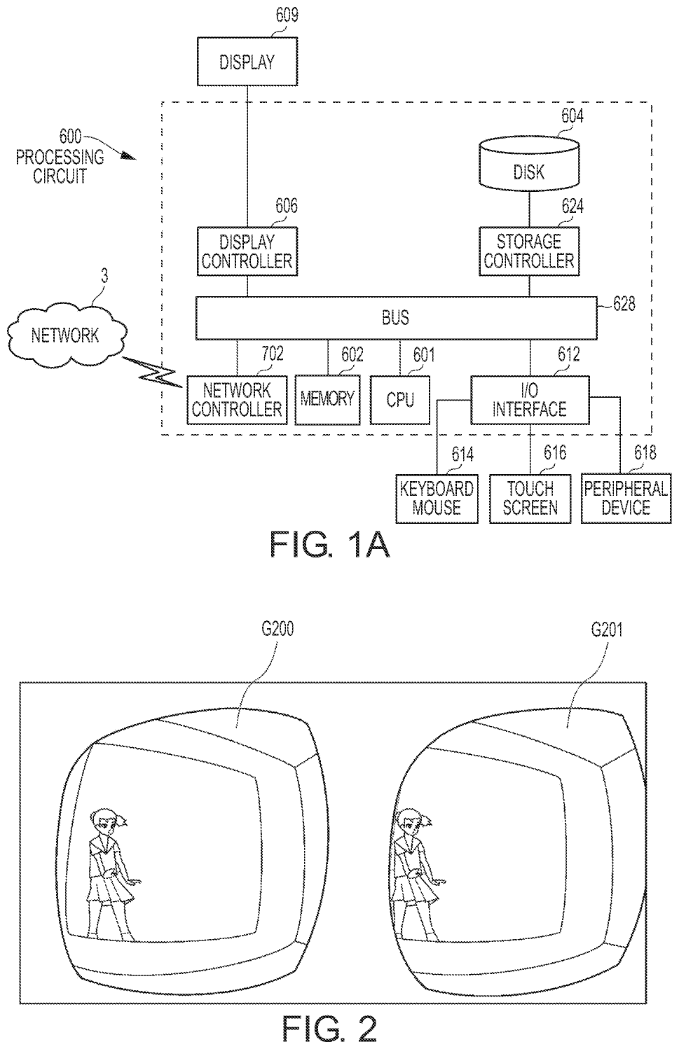

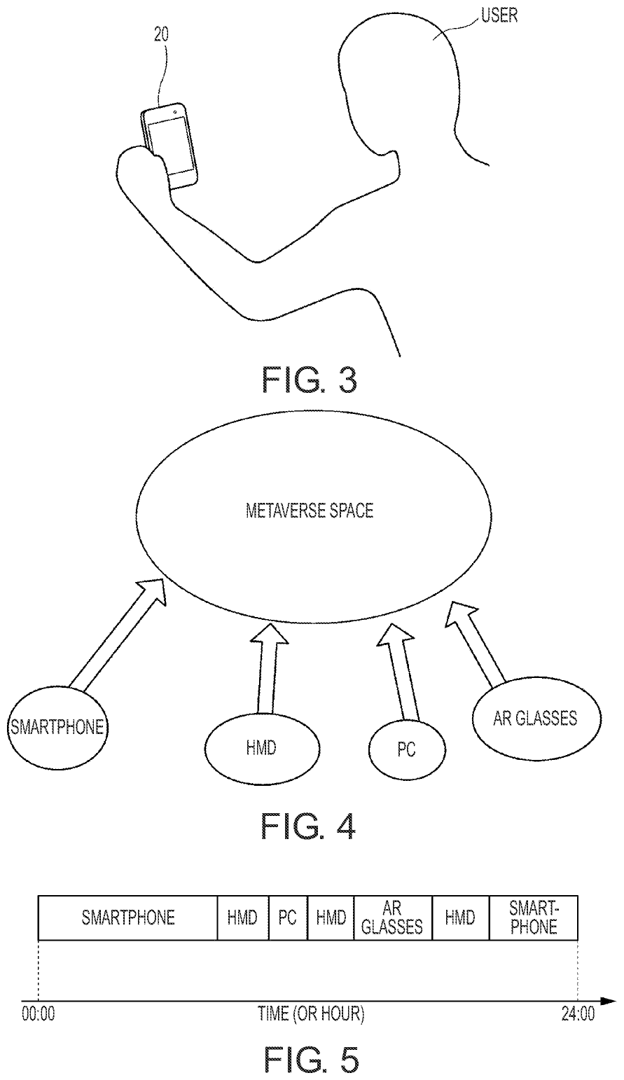

With reference to FIG. 1, an overview of a virtual reality generation system 1 according to an embodiment of this disclosure will be described. FIG. 1 is a block diagram of a virtual reality generation system 1 according to this embodiment. FIG. 2 is an explanatory diagram of a terminal image that can be viewed through a head-mounted display. FIG. 3 is an explanatory diagram of a terminal image that can be viewed via a smartphone.

A chat-related support system 1 includes a server device 10 and one or more terminal devices 20. Although three terminal devices 20 are illustrated in FIG. 1 for the purpose of simplicity, the number of terminal devices 20 may be two or more.

The server device 10 is an information system, for example, a server or the like managed by an administrator who provides one or more virtual realities. The terminal device 20 is a device used by a user, such as a mobile phone, a smartphone, a tablet terminal, a PC (Personal Computer), a head-mounted display, a game device, or the like. The terminal device 20 is typically different for each user. A plurality of terminal devices 20 can be connected to the server device 10 via a network 3.

The terminal device 20 can execute a virtual reality application according to this embodiment. The virtual reality application may be received by the terminal device 20 from the server device 10 or a predetermined application distribution server via the network 3. Alternatively, it may be stored in advance in a memory device provided in the terminal device 20 or in a memory medium such as a memory card that can be read by the terminal device 20. The server device 10 and the terminal device 20 are communicably connected via the network 3. For example, the server device 10 and the terminal device 20 cooperate to perform various processes related to virtual reality.

The terminal devices 20 are communicably connected to each other via the server device 10. Hereinafter, “one terminal device 20 sends information to another terminal device 20” means “one terminal device 20 sends information to another terminal device 20 via the server device 10.” Similarly, “one terminal device 20 receives information from another terminal device 20” means “one terminal device 20 receives information from another terminal device 20 via the server device 10.” However, in a modification, each terminal device 20 may be communicably connected without going through the server device 10.

The network 3 may include a wireless communication network, the Internet, a VPN (Virtual Private Network), a WAN (Wide Area Network), a wired network, or any combination of these, or the like.

Hereinafter, the virtual reality generation system 1 realizes an example of the information processing system, but each element of a specific terminal device 20 (see a terminal communication portion 21 to a terminal controller 25 in FIG. 1) may realize an example of the information processing system. Alternatively, a plurality of terminal devices 20 may work together to realize an example of the information processing system. Additionally, the server device 10 alone may realize an example of the information processing system. Alternatively, the server device 10 and one or more terminal devices 20 may work together to realize an example of an information processing system.

Here, a summary of a virtual reality according to this embodiment will be described. A virtual reality according to this embodiment is, for example, a virtual reality for any reality such as education, travel, role-playing, simulation, entertainment such as games and concerts, or the like. A virtual reality medium such as an avatar is used in execution of the virtual reality. For example, a virtual reality according to this embodiment is realized by a three-dimensional virtual space, various virtual reality media that appear in the virtual space, and various contents provided in the virtual space.

Virtual reality media are electronic data used in virtual reality, and include any medium such as cards, items, points, in-service currency (or virtual reality currency), tokens (for example, Non-Fungible Tokens (NFTs)), tickets, characters, avatars, parameters, or the like. Additionally, virtual reality media may be virtual reality-related information such as level information, status information, parameter information (physical strength, offensive ability, or the like) or ability information (skills, abilities, spells, jobs, or the like). Furthermore, the virtual reality media are electronic data that can be acquired, owned, used, managed, exchanged, combined, reinforced, sold, disposed of, or gifted or the like by a user in the virtual reality. However, usage of the virtual reality media is not limited to those specified in this specification.

An avatar is typically in the form of a character with a frontal orientation, and may have a form of a person, an animal, or the like. An avatar can have various appearances (appearances when drawn) by being associated with various avatar items. Additionally, hereinafter, due to the nature of avatars, a user and an avatar may be treated as the same. Therefore, for example, “one avatar does XX” may be synonymous with “one user does XX.”

Furthermore, in this specification, the term “association” includes not only direct association, but also indirect association. For example, it is a concept that also includes a state in which element B is associated with element A is not only a state in which element B is associated with element A, but also a state in which element C is associated with element A and element B is associated with element C.

A user may wear a mounted device on the head or a part of the face and visually recognize a virtual space through the mounted device. The mounted device may be a head-mounted display or a glasses-type device. A glasses-type device may be so-called AR (Augmented Reality) glasses or so-called MR (Mixed Reality) glasses. In any case, the mounted device may be separate from the terminal device 20, or may realize part or all of functions of the terminal device 20. The terminal device 20 may be realized by a head-mounted display.

FIG. 1A is a block diagram of a processing circuit 600 that executes a computer-based operation according to this disclosure. The processing circuit 600 described hereinafter is suitable as a hardware configuration for realizing a server communicator 11 to a server controller 13 of the server device 10 shown in FIG. 1. Furthermore, the processing circuit 600 described hereinafter is suitable as a hardware configuration for realizing a terminal communicator 21, a terminal memory 22, and a terminal controller 25 of the terminal devices 20 shown in FIG. 1.

The processing circuit 600 is used to control any computer-based and cloud-based control process. A description or block in a flowchart can be understood to represent a module, segment or portion of code containing one or more executable commands for implementing a specified logical function or step in a process. As will be understood by those skilled in the art, alternate implementations are included within a scope of this cutting-edge exemplary embodiment, such that functions may be performed in a different order than that shown or discussed, such as substantially concurrently or in reverse order, depending on the functionality involved. The functions of the elements disclosed in this specification may be implemented using a general purpose processor configured or programmed to perform the disclosed functions, a special purpose processor, an integrated circuit, ASIC (Application Specific Integrated Circuits), a conventional circuit and/or a combination thereof. A processor is a processing circuit or circuit because it includes transistors and other circuits therein. The processor may be a programmed processor executing programs stored in a memory 602. In this disclosure, any processing circuit, portion, or means is hardware that performs, or is programmed to perform, the functions mentioned. The hardware may be any hardware disclosed in this specification or otherwise known that is programmed or configured to perform the functions mentioned.

Additionally, in FIG. 1A, the processing circuit 600 includes a display controller 606, a storage controller 624, a network controller 702, a memory 602, an I/O interface 612, and the like that are connected via a bus 628. In this case, the processing circuit 600 is connected to a display 609 via the display controller 606 and is connected to a keyboard and mouse 614, a touch screen 616, and a peripheral device 618 via the I/O interface 612. Also, the processing circuit 600 has access to the network 3 via the network controller 702.

As shown in FIG. 1A, the processing circuit 600 includes a CPU 601 that executes one or more of the control processes discussed in this disclosure. Process data and commands may be stored in the memory 602. These processes and commands may also be stored on a storage medium disk 604 (shown as “disk” in FIG. 1A), such as a hard disk drive (HDD) or portable storage medium. Moreover, any form of computer readable medium on which the commands of the disclosed process may be stored is acceptable. For example, the commands may be stored on a CD, a DVD, a flash memory, a part of an information processing device with which the processing circuit 600 communicates such as a RAM, a ROM, a PROM, an EPROM, an EEPROM, or a hard disk, or another non-transitory computer readable medium such as a server or computer. In addition, a process may be stored in network-based storage, cloud-based storage, or other mobile-accessible storage, and be executable by the processing circuit 600.

Furthermore, various processes and the like may be provided as (i) the CPU 601, (ii) a utility application that runs in conjunction with an operating system such as Microsoft Windows (registered trademark), UNIX (registered trademark), Solaris (registered trademark), LINUX (registered trademark), Apple (registered trademark), MAC-OS (registered trademark), Apple iOS (registered trademark), and other systems known to those skilled in the art, (iii) a background daemon, (iv) a component of an operating system, or (v) a combination thereof.

The hardware elements for realizing the processing circuit 600 may be realized by various circuit elements. Furthermore, each function of the above-described embodiments may be realized by circuitry including one or more processing circuits. The processing circuit(s) includes a particularly programmed processor, for example, a processor (CPU) 601 as shown in FIG. 1A. The processing circuit(s) also includes devices such as an application specific integrated circuit (ASIC) and a conventional circuit component arranged to executed the functions mentioned.

In FIG. 1A, the processing circuit 600 may be a computer or a specified special purpose machine. The processing circuit 600 is programmed so as to execute processing for controlling implemented devices (server device 10 and terminal devices 20).

Alternatively or additionally, as will be recognized by those skilled in the art, the CPU 601 may be implemented on an FPGA (Field Programmable Gate Array), an ASIC, or a PLD (Programmable Logic Device), or may be implemented using a discrete logic circuit. Furthermore, the CPU 601 may be implemented as multiple processors working in parallel and cooperating to execute the commands of the various processes.

The processing circuit 600 of FIG. 1A also includes the network controller 702, such as an Ethernet PRO network interface card, for interfacing with the network 3. As can be understood, the network 3 can be a public network such as the Internet, or a private network such as a local area network (LAN) or wide area network (WAN), or any combination thereof. The network 3 can contain a Public Switched Telephone Network (PSTN) or Integrated Services Digital Network (ISDN), and a subnetwork. The network 3 may also be wired, such as a wired LAN network such as Ethernet, a Universal Serial Bus (USB) cable, or the like, or wireless, such as a cellular network including EDGE or 3G, 4G and 5G wireless cellular systems. Furthermore, the wireless network may be Wi-Fi (registered trademark), wireless LAN, Bluetooth (registered trademark), or other known forms of wireless communication. In addition, the network controller 702 may comply with other direct communication standards such as Bluetooth (registered trademark), Near Field Communication (NFC), infrared, and the like.

### (Configuration of Server Device)

Referring again to FIG. 1, a functional configuration of the server device 10 will be specifically described. The server device 10 may be implemented by a server computer. The server device 10 may be realized in cooperation with a plurality of server computers. For example, the server device 10 may be realized in cooperation with a server computer that provides various contents, a server computer that realizes various authentication servers, or the like. Furthermore, the server device 10 may also include a web server. In this case, part of the functions of the terminal device 20, which will be described hereinafter, may be realized by a browser processing an HTML document received from the web server and various programs (JavaScript (registered trademark)) attached thereto.

The server device 10 includes the server communicator 11, a server memory 12, and the server controller 13, as shown in FIG. 1.

The server communicator 11 includes an interface that performs wireless or wired communication with an external device to send and receive information. The server communicator 11 may include, for example, a wireless LAN (Local Area Network) communication module or a wired LAN communication module, or the like. The server communicator 11 can send and receive information to and from the terminal devices 20 via the network 3.

The server memory 12 is, for example, a storage device, and stores various information and programs required for various processes related to virtual reality.

The server controller 13 may include a dedicated microprocessor or a CPU (Central Processing Unit) that realizes a specific function by reading a specific program, a GPU (Graphics Processing Unit), and the like. For example, the server controller 13 cooperates with the terminal devices 20 to execute a virtual reality application according to user input.

The server controller 13 (the same applies to the terminal controller 25 hereinafter) may be constituted as circuitry including one or more processors that operate according to a computer program (software), one or more dedicated hardware circuits that execute at least part of various processes, or a combination thereof.

### (Configuration of Terminal Device)

Referring to FIG. 1 again, a functional configuration of the terminal devices 20 will be described. As shown in FIG. 1, a terminal device 20 is provided with a terminal communicator 21, a terminal memory 22, a display portion 23, an input portion 24, and a terminal controller 25.

The terminal communicator 21 communicates with an external device wirelessly or by wire, and includes an interface for sending and receiving information. The terminal communicator 21 may include, for example, a wireless communication module, a wireless LAN communication module, or a wired LAN communication module, or the like corresponding to a mobile communication standard such as LTE (Long Term Evolution) (registered trademark), LTE-A (LTE-Advanced), a fifth generation mobile communications system, or UMB (Ultra Mobile Broadband). The terminal communicator 21 can send and receive information to and from the server device 10 via the network 3.

The terminal memory 22 includes, for example, primary and secondary storage devices. For example, the terminal memory 22 may include a semiconductor memory, a magnetic memory, or optical memory, or the like. The terminal memory 22 stores various information and programs used in the processing of virtual reality that are received from the server device 10. The information and programs used in the processing of virtual reality may be acquired from an external device via the terminal communicator 21. For example, a virtual reality application program may be acquired from a predetermined application distribution server. Hereinafter, an application program is also referred to simply as an application.

Additionally, the terminal memory 22 may store data for drawing a virtual space, for example, an image of an indoor space such as a building, an image of an outdoor space, or the like. Also, a plurality of types of data for drawing a virtual space may be prepared for each virtual space and used separately.

Additionally, the terminal memory 22 may store various images (texture images) for projection (texture mapping) onto various objects placed in a three-dimensional virtual space.

For example, the terminal memory 22 stores avatar drawing information related to avatars as virtual reality media associated with each user. An avatar in the virtual space is drawn based on the avatar drawing information related to the avatar.

Also, the terminal memory 22 stores drawing information related to various objects (virtual reality media) different from avatars, for example, various gift objects, buildings, walls, NPCs (Non Player Characters), and the like. Various objects are drawn in the virtual space based on such drawing information. A gift object is an object that corresponds to a gift (present) from one user to another user, and is part of an item. A gift object may be a thing worn by an avatar (clothes or accessories), a decoration (fireworks, flowers, or the like), a background (wallpaper), or the like, or a ticket or the like that can be used for gacha (lottery). The term “gift” used in this application means the same concept as the term “token.” Therefore, it is also possible to replace the term “gift” with the term “token” to understand the technology described in this application.

The display portion 23 includes a display device, for example, a liquid crystal display or an organic EL (Electro-Luminescent) display. The display portion 23 can display various images. The display portion 23 is constituted by, for example, a touch panel, and functions as an interface that detects various user operations. Additionally, as described above, the display portion 23 may be in the form of a head-mounted display.

The input portion 24 may include physical keys or may further include any input interface, including a pointing device such as a mouse or the like. The input portion 24 may also be able to accept non-contact-type user input, such as sound input, gesture input, or line-of-sight input. Gesture input may use sensors (image sensors, acceleration sensors, distance sensors, and the like) to detect various user states, special motion capture that integrates sensor technology and a camera, and a controller such as a joypad. Also, a line-of-sight detection camera may be arranged in a head-mounted display. The user's various states are, for example, the user's orientation, position, movement, or the like. In this case, the orientation, position, and movement of the user include not only the orientation, position, and movement of part or all of the user's body, such as the face and hands, but also the orientation, position, movement, and the like of the user's line of sight.

The terminal controller 25 includes one or more processors. The terminal controller 25 controls the overall operation of the terminal device 20.

The terminal controller 25 sends and receives information via the terminal communicator 21. For example, the terminal controller 25 receives various information and programs used for various processes related to virtual reality from at least one of (i) the server device 10 and (ii) another external server. The terminal controller 25 stores the received information and programs in the terminal memory 22. For example, the terminal memory 22 may contain a browser (Internet browser) for connecting to a Web server.

The terminal controller 25 activates a virtual reality application in response to a user operation. The terminal controller 25 cooperates with the server device 10 to execute various processes related to virtual reality. For example, the terminal controller 25 displays an image of the virtual space on the display portion 23. On the screen, for example, a GUI (Graphical User Interface) may be displayed that detects a user operation. The terminal controller 25 can detect a user operation via the input portion 24. For example, the terminal controller 25 can detect various operations by user gestures (operations corresponding to a tap operation, a long tap operation, a flick operation, a swipe operation, and the like). The terminal controller 25 sends the operation information to the server device 10.

The terminal controller 25 draws an avatar or the like together with the virtual space (image), and causes the display portion 23 to display a terminal image. In this case, for example, as shown in FIG. 2, a stereoscopic image for a head-mounted display may be generated by generating images G200 and G201 that can be viewed with the right and left eyes, respectively. FIG. 2 schematically shows the images G200 and G201 that can be viewed by the right and left eyes, respectively. Hereinafter, unless otherwise specified, images in the virtual space refer to the entire images represented by the images G200 and G201. Additionally, the terminal controller 25 realizes various movements and the like of the avatar in the virtual space, for example, according to various operations by a user. Alternatively, as schematically shown in FIG. 3, the user may view the virtual space via a terminal device 20 in the form of a smartphone.

The virtual space described below is an immersive space that can be viewed using a head-mounted display or the like, and is a concept that includes not only a continuous three-dimensional space in which the user can freely (like in real life) move around via an avatar, but also a non-immersive space that can be viewed using a smartphone or the like as described above with reference to FIG. 3. Additionally, a non-immersive space that can be viewed using a smartphone or the like may be a continuous three-dimensional space in which the user can freely move around via an avatar, or a two-dimensional discontinuous space. Hereinafter, when distinguishing, a continuous three-dimensional space in which a user can freely move around via an avatar is also referred to as a “metaverse space.”

Also, various objects and facilities (for example, movie theaters) that appear in the following description are objects in virtual space and are different from real objects, unless otherwise specified. Also, various events in the following description are various events (for example, screening of movies, and the like) in virtual space, and are different from events in reality.

Further, hereinafter, an object corresponding to an arbitrary virtual reality medium (for example, a building, a wall, a tree, or an NPC, or the like) different from an avatar and drawn in the virtual space will also be referred to as a second object M3. In this embodiment, the second object M3 may include an object that is fixed within the virtual space, an object that is movable within the virtual space, or the like. Also, the second object M3 may include an object that is constantly placed in the virtual space, an object that is placed only when a predetermined placement condition is satisfied, or the like.

The types and number of contents provided in the virtual space (contents provided in virtual reality) are arbitrary. In this embodiment, as an example, the content provided in the virtual space includes digital content such as various videos. The video may be real-time video or non-real-time video. Also, the video may be a video based on a real image, or may be a video based on CG (Computer Graphics). The video may be a video for providing information. In this case, the video may be related to an information provision service of a specific genre (information provision service related to travel, housing, food, fashion, health, beauty, or the like), a broadcast service by a specific user (for example, YouTube (registered trademark)), or the like.

Incidentally, there are various methods of user access to the metaverse space. For example, as conceptually shown in FIG. 4, regarding the terminal devices 20, access is possible through various types of terminal devices 20 (examples of electronic devices) including a head-mounted display (including so-called VR goggles, VR glasses, and the like), a smartphone, a personal computer, AR (Augmented Reality) glasses (including so-called smart glasses and the like), and the like.

In addition, the status of users in reality is diverse, such as working, sleeping, eating, traveling, and staying in the metaverse space. A status is a concept that includes an environment. For example, one user's status may include the surrounding environment surrounding the one user.

Each user can interact via various terminal devices 20 while having various statuses that can be different from each other.

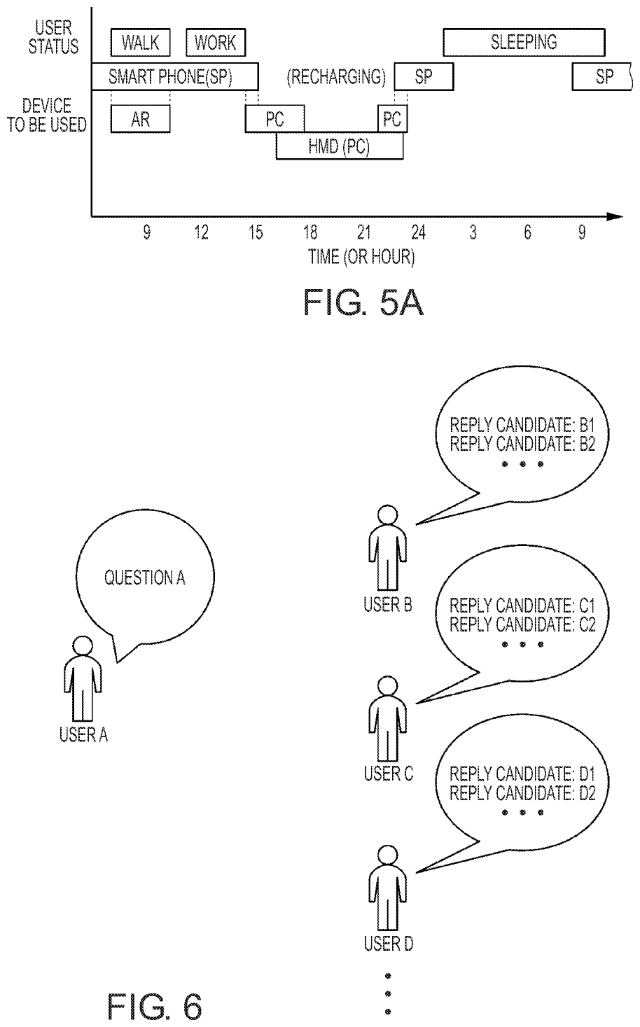

In this way, each user can conduct chat-style communication among a plurality of users while appropriately using various terminal devices 20 while changing his or her status in reality. Thus, for example, each user can spend a day or more in a constantly connected state (that is, a state of being connected with other users). For example, in the example shown in FIG. 5, an example of a time series of terminal devices 20 (hereinafter also simply referred to as “used devices”) used for a constant connection for a user from 0:00 to 24:00 is shown. In addition, each user (for example, users who are friends) can decide a meeting place or the like through chat-type communication, move to a predetermined place in the metaverse space (for example, a usual meeting place) as appropriate, and meet, play, talk, and more at that place. Furthermore, in the example shown in FIG. 5A, the time (or time period) is taken as the horizontal axis, and the user status (User Status) and the time series of the devices used are shown. FIG. 5A shows a pattern for one particular day, but the pattern may vary depending on the day of the week, season, or the like. In the example shown in FIG. 5A, simultaneous access (or interlocking) with a smartphone is realized in conjunction with (cooperation with) AR glasses while the user is moving. In this case, an operation on the smartphone and a display function on the AR glasses may be coordinated. Additionally, after returning home, the user starts up a personal computer, and switching from the smartphone to the personal computer has been realized. Accordingly, the personal computer and the smartphone may be mutually exclusive (cannot be used at the same time). The user may associate a head-mounted display with the personal computer while using the personal computer. However, the user may use the head-mounted display as a stand-alone.

Hereinafter, various types of information processing that can effectively support chat-type communication as described above will be described. However, although the various types of information processing described hereinafter are suitable for chat-style communication, they can also be applied to other applications. The chat format refers to a format different from a voice call, such as a message, a text (pictograms or the like), a symbol, an image (stamp or the like), or the like. The chat format does not exclude sound, and may include, for example, a format in which a stamp with sound attached can be used.

Hereinafter, unless otherwise specified, each user refers to each user who is connected for chat-style communication and belongs to one chat group. “Connected” refers to a state in which mutual communication is possible via the terminal devices 20 connected to the network 3 described above. Also, a chat group may be a pre-registered group or a group formed on the spot. Additionally, users participating in one chat group may be fixed or may change dynamically.

In this embodiment, first, when something is sent from one user, a plurality of options is generated for reply content of a reply from a receiving side in response to the sent content. In this case, if the user at the receiving side has a desired option among the plurality of options, s/he simply selects it to complete the reply, which enhances convenience.

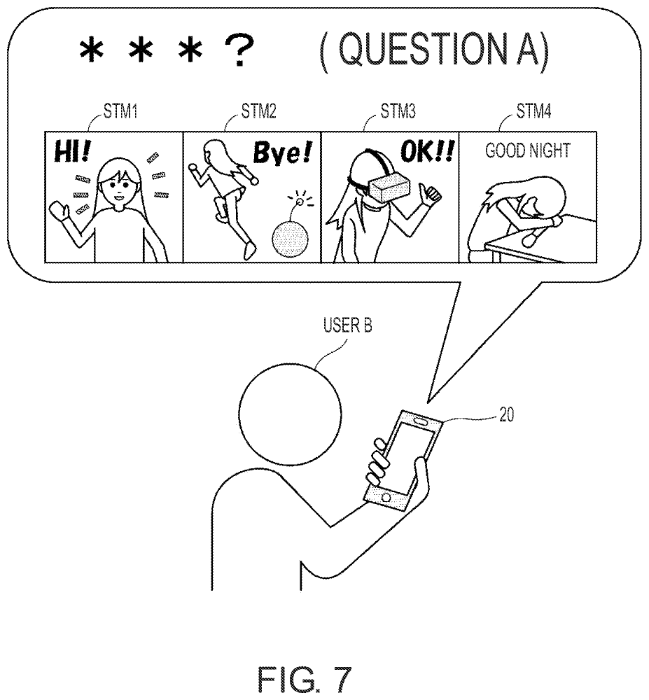

FIGS. 6 and 7 are diagrams conceptually showing states in which a plurality of options are presented for reply content from each other user with respect to sent content from one user. The conversations shown in FIGS. 6 and 7 relate to chat-style communication. Also, in the following description, terms representing locations such as a bank represent locations in the metaverse space unless otherwise specified.

In FIG. 6, when user A's “Question A” is received by each of the other users (only three users B, C, and D are shown), each user is presented with a plurality of options. Each option may include a message, a text (such as a pictogram), a symbol, an image (such as a stamp), or the like. For example, user B is presented with reply candidates B1, B2, and the like. Similarly, user C is presented with reply candidates C1, C2, and the like, and user D is presented with reply candidates D1, D2, and the like. In this case, for example, if user B has a desired option from among the plurality of options B1, B2, and the like, the reply is completed by simply selecting it, which enhances convenience. For example, FIG. 7 shows a state in which user B is presented with four options STM1 to STM4 for “Question A.” In FIG. 7, the four options STM1 to STM4 are displayed together with sent content (“Question A”), but they may be displayed (presented) separately from the sent content. In either case, if user B has a desired option from among the four options STM1 to STM4, s/he can reply by simply selecting it.

In this embodiment, a plurality of options presented to each user at the receiving side is generated based on the sent content (“Question A” in this example). For example, the plurality of options may include an option that can be a reply in response to the sent content. In this example, some or all of the plurality of options may be meaningful options as a response to Question A. A meaningful option as a response to Question A is, for example, in response to Question A=“Would you like to go to location A now?”, each option including a message such as “I'm going now,” “I can't do it today,” “I'm going to bed soon,” “I like Location B,” or “I don't have money,” or a pictogram or a stamp directly or indirectly expressing these contents.

The plurality of options may include options that do not make sense as a response to the sent content. Options that do not make sense as a response to the sent content may be options that include messages that have little or no relevance to the sent content, or the like. For example, an option that does not make sense as a response to Question A may be an option that includes a message or the like that does not answer the question. For example, in response to Question A=“Would you like to go to location A now?”, messages, such as “This side dish is delicious,” and “The dog is cute,” mysterious pictograms, or the like, or each option including a pictogram and/or stamp that directly or indirectly represent these contents, can be an option that does not make sense as a response to Question A.

For example, in an embodiment, there may be four types of options presented to the user: (i) a type of option that directly indicates something (hereinafter also referred to as “direct response type option”), (ii) an option that indirectly indicates the same item (hereinafter, also referred to as “indirect response type option”), (iii) an option that is unrelated to the same matter (hereinafter, also referred to as “first unrelated response type option”), and (v) an option related to a topic different from the same matter (hereinafter, also referred to as “second unrelated response type option”). The first non-relevant response type option may include, for example, an option containing a stamp for which it is unclear what it means to the other party. Also, the second non-relevant response type option may include, for example, an option including a message, such as “This side dish is delicious” or “The dog is cute,” in response to Question A=“Would you like to go to location A now?”, or the like.

Here, whether or not it makes sense as a response to sent content can be a relative concept. For example, in this case, an option may also be a direct response type option, an indirect response type option, or a first unrelated response type option. In consideration of this point, information for distinguishing the attributes of options such as the four types of options described above may be given to each option. For example, a predetermined flag (an example of a second parameter) may be associated in advance with each option. For example, an option (an example of a third option) associated with a predetermined flag value of “1” (an example of a first value) is treated as an option that makes sense as a response to the sent content, and an option (an example of a fourth option) associated with a predetermined value of “0” (an example of a second value) may be treated as an option that does not make sense as a response to the sent content.

Additionally, the predetermined flag may have a flag function for distinguishing approval/rejection with respect to an option that makes sense instead of or in addition to a flag function for distinguishing between making sense and not making sense. For example, an option associated with the predetermined flag value “1” may be treated as an option indicating approval with respect to the sent content, and an option associated with the predetermined flag value “0” may be treated as an option indicating rejection with respect to the sent content. For example, when one user selects an option indicating approval with respect to the sent content inviting to some type of gathering, the user is sent a link for moving to a location related to the gathering, or may be managed as an attendee for the gathering. Furthermore, the predetermined flag may be able to distinguish more meanings, that is, approval, rejection, pending, and other, in addition to the flag function for distinguishing approval/rejection. In this case, four types of options corresponding to the four types of responses, that is, approval, rejection, pending, and other, may be presented, and the user's schedule management may be reflected (updated) according to the type of option selected by the user. In this case, “pending/other” may be classified as “not making sense” in the distinction between making sense and not making sense.

In this embodiment, even if the sent content is the same (“Question A” in this embodiment), the reply options can be different for different users. For example, reply candidates C1, C2, and the like presented to user C and reply candidates D1, D2, and the like presented to user D may be partially or entirely different. In this case, for example, a plurality of options may be generated based on an arbitrary parameter (an example of a first parameter) associated with each user. For example, a plurality of options presented to one user may include at least one of: (i) a type of terminal device 20 possessed by the user, (ii) an item in the metaverse space possessed by the user, (iii) a status of the user, and (v) a relationship between the user and the sending-side user (for example, user A in FIG. 6).

“Reply candidates being different” is a concept that includes an aspect in which expressions are different even if the content is the same. For example, even if the content is the same, the dialect or language may differ. For example, for a user originally from Osaka, an option may be presented which includes a message in Kansai dialect. Also, “reply candidates being different” may mean, for example, a different form of an avatar that may be used as a stamp. For example, an avatar may be a unique avatar for each user, and differences such as different poses depending on the type of avatar (male, female, other) may be realized.

Thus, according to this embodiment, it is possible to present options for each user that can handle diversity, such as diversity of the user himself/herself, diversity related to the user, and diversity of a status of the user. As a result, the possibility of presenting desired options to each user increases, convenience improves, and the processing load when the terminal device 20 responds to the user's retyping of a message or the like can be reduced.

In this embodiment, the plurality of options may include an option (hereinafter, when distinguishing from other options, it will be referred to as a “moving type option”) (an example of a first option) associated with a destination in a metaverse space that can be viewed via the terminal device 20. Furthermore, the moving type option may be presented at each reply timing in a conversation in which a plurality of exchanges are made, or may be presented only at some reply timings. For example, if the sent content is content that proposes movement within the metaverse space, a plurality of options generated based on the sent content may include a moving type option. Alternatively, a moving type option may be included as an option that does not make sense in response to the sent content, as described above.

The destination in the metaverse space associated with the moving type option may be any location in the metaverse space. For example, in response to Question A=“Would you like to go to location A now?,” the destination in the metaverse space associated with the moving type option may be location A in the metaverse space, or the entrance of location A. The latter is preferred if location A is a relatively large facility with an entrance. If location A is a facility or the like that only a user having authorization such as a ticket can enter, the destination in the metaverse space associated with the moving type option may be an authorization obtaining location such as a ticket sales office.

The moving type option may also be generated in a manner that may vary from user to user based on arbitrary parameters associated with each presented user. For example, in response to Question A=“Would you like to go to location A now?”, if location A is a paid facility or the like and the corresponding user does not have sufficient money, the destination in the metaverse space associated with the moving type option presented to the user may be a bank, an ATM, or the like. In this case, a new option may be generated when the shortage of money is resolved at a bank, ATM, or the like. In this case, the location A may be the destination in the metaverse space associated with the moving type option presented to the user. On the other hand, if the corresponding user does have sufficient money, the location A may be the destination in the metaverse space associated with the moving type option presented to the user.

The moving type option may include a link to the destination. In this case, the user who desires to move to the destination can use the link to move to the destination, thereby improving convenience. Even if the destination itself is the same, the link to the destination may differ depending on the terminal device 20 used (that is, device used) for access. For example, the link may differ when the device used is a head-mounted display and when the device used is a smartphone. In addition, for the link, a variety of deep links may be used that may vary depending on an OS (Operating System), a platform, and the like that are used.

The moving type option may be associated with a link that may be included in corresponding sent content. For example, if the corresponding sent content includes the message “Would you like to go to location A now?” and a URL display related to that location, the moving type option may be associated with a link related to the URL display.

When such a moving type option is selected by the user, that is, when a response (an example of a first response) based on the moving type option is made, movement-related processing to the destination associated with the moving type option for which the response was made may be executed.

The movement-related processing may include at least one of (i) processing that causes movement to the destination, and (ii) processing that outputs a display that enables movement to the destination. The processing that causes movement to the destination may be (i) automatic processing that is unconditionally executed when the user selects the moving type option, or (ii) processing that is executed under an additional condition. The same applies to the processing that outputs a display that enables movement to the destination. The display that enables movement to the destination may be (i) the link itself, or (ii) a user interface for receiving a predetermined input for executing the link. In the case of the processing that outputs a display (user interface) that enables movement to the destination, the user may be able to move to the destination by viewing the display and performing a predetermined input.

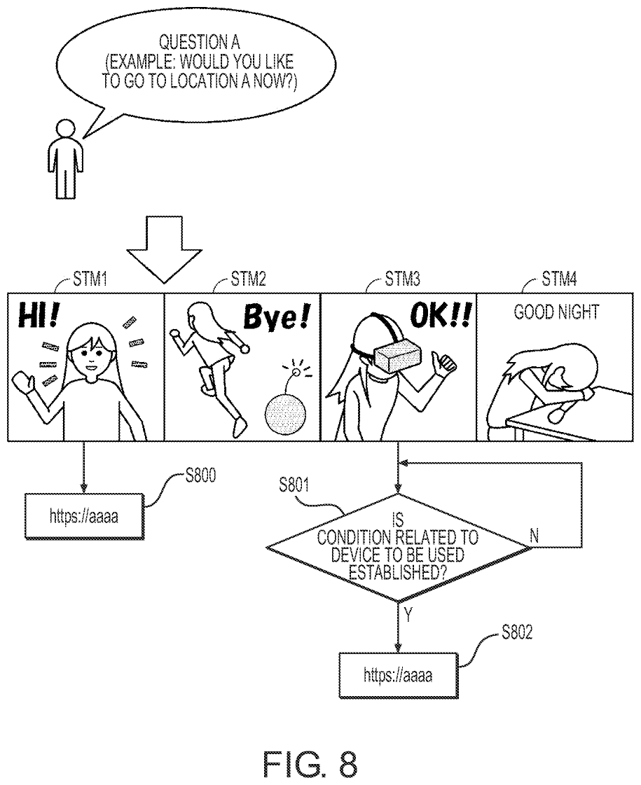

FIG. 8 is an explanatory diagram of movement-related processing, and is an explanatory diagram related to a plurality of options.

FIG. 8 shows four options STM1 to STM4 for “Question A” as shown in FIG. 7. Here, Question A=“Would you like to go to location A now?”

Option STM1 includes characters such as “Hi!” which means “OK.” Thus, this is a moving type option that contains a message that makes sense as a response. When such option STM1 is selected, as shown in FIG. 8, the link corresponding to location A (here, “https://aaaa”) is executed (that is, accessing the link https://aaaa), movement to location A may be realized as movement-related processing (step S800). The link may be a link whose processing changes depending on the user's terminal device 20 or application. In this case, the terminal device 20 of the user who accesses the link becomes the terminal device 20 used by the user when the option STM1 is selected. Also, the link associated with option STM1 may be accessible only by a user participating in a chat in which the link is attached. Further, the link associated with option STM1 may be activated on the condition that a password such as a catchword between friends is entered. In this case, it is possible to suppress unintended participation or the like by a third party. Additionally, the link associated with option STM1 may be set with an expiration date according to a meeting time or the like.

Option STM2 is an option including a message that makes sense as a response because it includes characters such as “Bye!” which means “NO.” However, because it is “NO,” it is an option that is not associated with the destination. In this case, movement-related processing may be prohibited. When a reply representing such a “refusal” is made, a link to a location where user B can leave a message or the like may be presented. In this case, when user B leaves a message or video (for example, a message or video of refusal), the link may be sent to user A (the user who asked “Question A”).

Option STM3 is a moving type option including a message that makes sense as a response because it includes a picture of a hand pointing a good sign (OK sign) that means “OK.” In addition, since option STM3 contains a picture of a head-mounted display, it contains information suggesting a device to be used. When such option STM3 is selected, as shown in FIG. 8, if a condition related to the device to be used is satisfied (“YES” in step S801), then as shown in FIG. 8, a link (here, “https://aaaa”) corresponding to location A may be executed. In this case, the condition related to a device to be used may be satisfied when a corresponding used device is used. That is, in the case of this example, when the user B wears a head-mounted display, the link corresponding to the location A (here, “https://aaaa”) is executed, whereby movement to location A may be realized as movement-related processing (step S802).

Option STM4 is an option that includes a message that makes sense as a response because it includes characters such as “good night” which means “NO.” However, because it is “NO,” it is an option that is not associated with the destination. In this case, movement-related processing may be prohibited. Option STM4 may be automatically selected when user B is asleep. For example, based on sensor information or the like from a biosensor that can be worn by user B, it may be determined whether the user B is asleep.

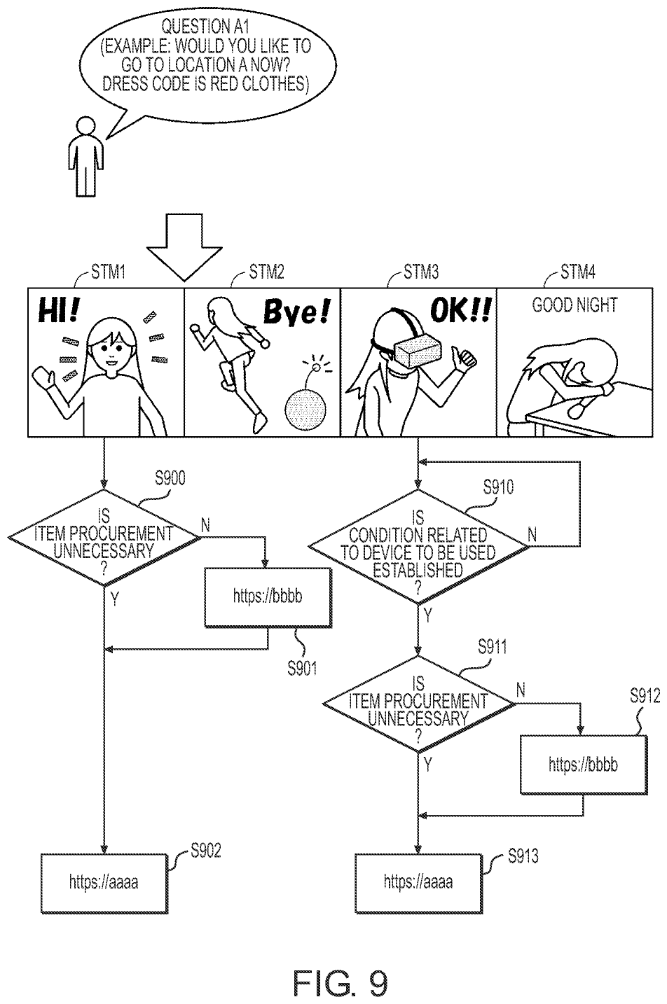

FIG. 9 is an explanatory diagram of movement-related processing, and an explanatory diagram related to a plurality of options.

FIG. 9 shows four options STM1 to STM4 for “Question A1.” Here, it is assumed that Question A1=“Would you like to go to location A now? The dress code is red clothes.” The options STM2 and STM4 may be the same as in the example described above with reference to FIG. 8, and description thereof will be omitted.

Option STM1 is a moving type option including a message that makes sense as a response because it includes characters such as “Hi!” which means “OK.” When such option STM1 is selected, as shown in FIG. 8, the link corresponding to location A may be immediately executed, but it also may be determined whether item procurement corresponding to “The dress code is red clothes” is required (step S900). That is, it may be determined whether user B has red clothes (the red clothes to be worn by the corresponding avatar). As a result of the determination, if it is determined that item procurement is unnecessary, the link corresponding to location A may be executed as is (step S902). However, if there are multiple red clothes, User B may select which clothes to wear. Also, when user B has red clothes but wants to procure new red clothes, it may be possible to proceed to step S901 according to an instruction from the user. On the other hand, as a result of the determination, for example, if it is determined that user B does not have red clothes and needs item procurement, a link (here, “https://bbbb”) may be executed (step S901). In addition, if there are multiple other places where red clothes can be procured, it may be possible for user B to select. In addition, red clothes are described here, but other items may be considered, such as red shoes and red hats. Also, another place where red clothes can be procured is not limited to a shop (for example, a clothing store), and is arbitrary. For example, moving to another location where red clothes can be procured may be realized by executing a lottery game (gacha) where red clothes can be procured. Also, another place where red clothes can be procured may be a place where red clothes can be rented or where items can be exchanged. Further, moving to a place where items can be exchanged may be realized by switching to a bulletin board for exchanging items or a chat screen with a user who owns red clothes.

Option STM3, similar to option STM1, is a moving type option including a message that makes sense as a response. In this case also, similar to the example described above with reference to FIG. 8, a condition related to the device to be used may be determined (step S910), and if the condition related to the device to be used is satisfied (“YES” in step S910), it may be determined whether item procurement is necessary, as shown in FIG. 9 (step S911). Steps S912 and S913 hereinafter are the same as steps S901 and S902 in the case of option STM1, respectively.

Thus, according to this embodiment, when a response is made based on a moving type option, movement-related processing to the destination corresponding to the moving type option is executed. Thus, the user does not need to find a link to access the destination, and convenience improves. Additionally, if the moving type option that has been selected includes a message or the like representing a device to be used, by determining the condition related to the device to be used, it is possible to suppress access to the destination based on the use of a terminal device 20 not intended by the user. Also, when information related to an item is included in sent content corresponding to the moving type option, it is determined whether item procurement is necessary. Thus, it is possible to suppress access to the destination at a timing not intended by the user (for example, at a timing when preparation is not complete). By thus suppressing access not desired by the user, the processing load can be reduced.

Furthermore, according to this embodiment, a plurality of options includes, in addition to an option (an example of the first option) in which the status of the user who makes a selection changes when the option is selected, such as the above-described options STM1 and STM3, an option (an example of the second option) in which the status of the user who makes a selection does not change when the option is selected, such as the above-described options STM2 and STM4. As a result, it is possible to present options to the user that are suitable for various timings, such as a timing at which an option accompanied by a change in status is not desired, or conversely, a timing at which an option accompanied by a change in status is desired.

In this embodiment, when one user is positioned in a metaverse space, when new sent content is sent to the user from another user as well, the above-mentioned plurality of options may be presented to the user.

Next, referring to FIG. 10 and after, a function related to the above-mentioned options (hereinafter also referred to as an “option-related function”) will be further explained.

Hereinafter, each element (referring to the terminal communicator 21 through the terminal controller 25 of FIG. 1) of terminal device 20 that performs processing related to the option-related function realizes an example of the information processing system, but the server device 10 may realize an example of the information processing system, and a plurality of terminal devices 20 may work together to realize an example of the information processing system. In addition, the server device 10 and one or more terminal devices 20 may work together to realize an example of the information processing system.

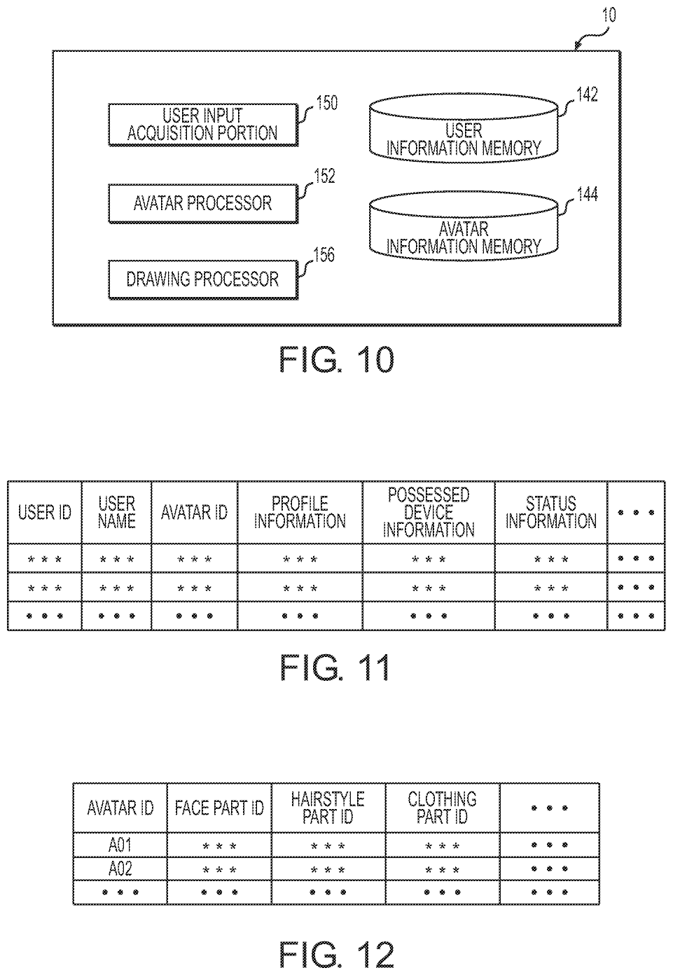

FIG. 10 is an example of a functional block diagram of the server device 10 related to the option-related function. FIG. 11 is an explanatory diagram of data in a user information memory 142. FIG. 12 is an explanatory diagram of data in an avatar information memory 144.

As shown in FIG. 10, the server device 10 includes the user information memory 142 and the avatar information memory 144. Furthermore, the user information memory 142 and the avatar information memory 144 can be realized by the server memory 12 shown in FIG. 1.

Additionally, as shown in FIG. 10, the server device 10 includes a user input acquisition portion 150, an avatar processor 152, and a drawing processor 156. The user input acquisition portion 150 through the drawing processor 156 can be realized by the server controller 13 shown in FIG. 1.

Furthermore, part or all of the function of the server device 10 explained hereinafter can be realized by the terminal device 20 as appropriate. For example, part or all of the function of the avatar processor 152 and the drawing processor 156 may be realized by the terminal device 20. Additionally, classification of the user information memory 142 and the avatar information memory 144, and classification of the user input acquisition portion 150 through the drawing processor 156, are for convenience of explanation, and part of the functional portions may realize functions of other functional portions. For example, part or all of data of the user information memory 142 may be integrated with data in the avatar information memory 144 or stored in another database.

User information related to each user is stored in the user information memory 142. Information regarding each user may be generated, for example, at the time of user registration, and then updated as appropriate. For example, in the example shown in FIG. 11, in the user information memory 142, user names, avatar IDs, profile information, possessed device information, status information, and the like are stored in association with user IDs.

Each user ID is an ID that is automatically generated at the time of user registration.

Each user name is a name registered by a respective user, and is optional.

Each avatar ID is an ID representing the avatar used by the user. Avatar drawing information for drawing a corresponding avatar (see FIG. 12) may be associated with each avatar ID. The avatar drawing information associated with one avatar ID may be able to be added to or edited based on input from the corresponding user, or the like.

Profile information is information representing a user profile (or avatar profile), and may be generated based on input information from the user. Also, the profile information may be selected via a user interface generated on the terminal device 20, and be provided to the server device 10 as a JSON (JavaScript Object Notation) request or the like.

Possessed device information includes information related to the terminal device(s) 20 possessed by the user. For a user having a plurality of types of terminal devices 20, information that can specify the corresponding plurality of types of terminal devices is stored as possessed device information.

Status information includes information representing the current status of the user.

Avatar drawing information for drawing each user's avatar is stored in the avatar information memory 144. In the example shown in FIG. 12, in the avatar drawing information, each avatar ID is associated with a face part ID, a hairstyle part ID, a clothing part ID, and the like. Parts information related to appearance such as face part IDs, hairstyle part IDs, and clothing part IDs are parameters that characterize avatars, and may be selected by each user. For example, a plurality of types of information related to appearance such as a face part ID, a hairstyle part ID, a clothing part ID, and the like related to an avatar are prepared. Also, regarding face part IDs, part IDs may be prepared for each type of face shape, eyes, mouth, nose, and the like. Information related to face part IDs may be managed by combining the IDs of the parts that make up the face. In this case, it is possible to draw each avatar not only at the server device 10, but also at the terminal device 20 side, based on each ID related to appearance linked to each avatar ID.

The user input acquisition portion 150 acquires various user inputs by each user via communication with the terminal device 20 of the corresponding user. Various inputs are as described above. Furthermore, the status and used device of each user may be determined based on user input that is acquired by the user input acquisition portion 150 (and the terminal information and the like that may be sent along with the user input). The user input acquisition portion 150 may also acquire information for updating possessed device information of the user (that will be described hereinafter), status information (that will be described hereinafter), and the like.

The avatar processor 152 determines movement of an avatar (change in position, movement of each part, and the like) based on various inputs by each corresponding user for each avatar. Additionally, the avatar processor 152 may realize a chat (conversation) between avatars in the metaverse space.

The drawing processor 156 generates an image (terminal image) that is an image in a virtual space including an avatar, and which can be viewed at the terminal device 20. The drawing processor 156 generates an image (image for the terminal device 20) for each avatar, based on a virtual camera corresponding to each avatar.

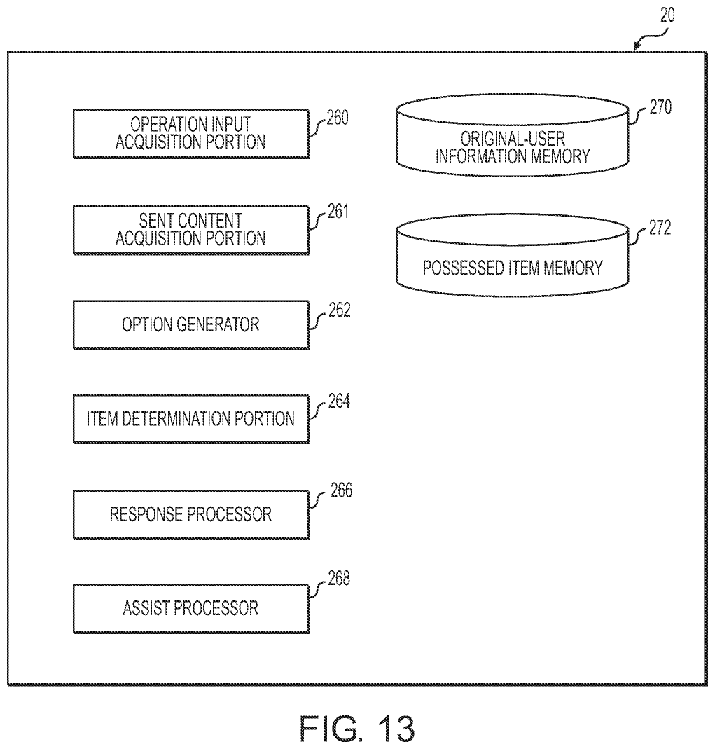

FIG. 13 is an example of a functional block diagram of one terminal device 20, related to the option-related function. Hereinafter, an original user is a user that possesses a corresponding terminal device 20. Furthermore, one user may have various types of terminal devices 20. Therefore, an original user related to a terminal device 20 may be identical to an original user related to another terminal device 20.

Part or all of the function of the terminal device 20 that will be explained hereinafter may be realized by the server device 10 as appropriate. For example, part or all of the function of an option generator 262 and an item determination portion 264 may be realized by the server device 10. Furthermore, classification of an original-user information memory 270 and a possessed item memory 272, and classification of an operation input acquisition portion 260 through a support processor 268, are for convenience of explanation, and part of the functional portions may realize functions of other functional portions.

The terminal device 20 includes an operation input acquisition portion 260, a sent content acquisition portion 261 (an example of an acquisition portion), an option generator 262, the item determination portion 264 (an example of a determination portion), a response processor 266, the support processor 268, an original-user information memory 270, and a possessed item memory 272. The operation input acquisition portion 260 through the support processor 268 can be realized by the terminal controller 25 shown in FIG. 1. The original-user information memory 270 and the possessed item memory 272 can be realized by the terminal memory 22 shown in FIG. 1.

The operation input acquisition portion 260 acquires various user inputs by the original user that are input via the input portion 24 of the terminal device 20. Various inputs are as described above.

The sent content acquisition portion 261 receives sent content from another user as described above. As described above, the sent content is related to chat-style communication between a plurality of users, including the original user.

Based on the sent content from the other user as described above, the option generator 262 generates the plurality of options described above with reference to FIG. 6 and the like, and presents it to the original user. The option generator 262 may present the generated plurality of options to the original user by displaying the generated plurality of options on the display portion 23. For example, the option generator 262 may position and superimpose the plurality of options in the vicinity of a newest position in chronological order on the chat screen.

As described above, the option generator 262 generates a moving type option based on the sent content. For example, as in the above example, if the sent content is “Would you like to go to location A now?,” the option generator 262 generates a moving type option associated with the location A. For example, the moving type option may include a link that allows movement to location A. In this case, if a link that allows movement to location A is included in the sent content, the link may be used. On the other hand, if a link that allows movement to location A is not included in the sent content, a link that allows movement to location A may be generated by the option generator 262. In this case, the link may be generated for each type of terminal device 20 owned by the original user.

As described above, the option generator 262 may generate a plurality of options, based on an arbitrary parameter associated with the original user. That is, the option generator 262 may include at least one of (i) a type of the terminal device 20 possessed by the original user, (ii) an item in the metaverse space possessed by the original user, (iii) a status of the original user, and (iv) a relationship between the original user and the sending-side user (the other user that has sent the sent content related to the option of this time).

For example, when the terminal device 20 to be used is included in the option, the option generator 262 may determine the terminal device 20 to be used, based on the type of terminal device(s) 20 possessed by the original user. For example, as in the above example, if the sent content is “Would you like to go to location A now?,” if a plurality of options includes “I will go there by OO!,” the OO included in the message may be determined according to the type(s) of terminal device 20 possessed by the original user. For example, if the types of the terminal device 20 possessed by the original user are a smartphone and a head-mounted display, two types of messages of “I'll go by smartphone!” and “I'll go by HMD!” may be generated. In this case, for example, a message related to a type of terminal device 20 not possessed by the original user does not generate an option including a message, for example, “I'll go by tablet!” As a result, accuracy of a plurality of options (a possibility of the original user selecting an option) can be increased. Furthermore, from a similar point of view, by analyzing trends in the period of time the original user used devices in the past, an option showing a device with high possibility of being used may be preferentially displayed according to the meeting time.

Additionally, the option generator 262 may further determine the terminal device 20 to be used depending on whether a smartphone and another terminal device 20 are linked by Bluetooth (registered trademark) or the like. This is because even if the user owns a head-mounted display, s/he cannot use the head-mounted display unless s/he possesses it at that time (for example, if s/he is not at home). Also, in a situation in which the head-mounted display cannot be worn immediately, such as when the user is out of the office/house, for example, when the user is already wearing AR glasses, the AR glasses may be determined as the terminal device 20 to be used.

Furthermore, the option generator 262 may further determine the terminal device 20 to be used based on the user's current location information, depending on whether the user's current location is home, office, or other (while moving). This is because as described above, even if the user owns a head-mounted display, s/he cannot use the head-mounted display unless s/he has it at that time (for example, if s/he is not at home). For example, if the user's current location is an office, a smartphone that can respond only with text or sound may be determined as the terminal device 20 to be used. If the user's current location is home, the head-mounted display may be determined as the terminal device 20 to be used. If the user's current location is changing (that is, moving), a combination of AR glasses and a smartphone may be determined as the terminal device 20 to be used. A combination of AR glasses and a smartphone is ideal for a situation in which the user can only read text or hear sounds but not speak, such as when the user is on the move. The user's current location information may be acquired by the user input acquisition portion 150 as part of the status information of the user.

Furthermore, for example, the option generator 262 may determine an item name that may be included in the option according to an item in the metaverse space possessed by the original user. For example, as in the above-described example, if the sent content is “Would you like to go to location A now? The dress code is red clothes.,” if a plurality of options includes “I'll go in AA!,” the AA included in the message may be determined according to the item(s) possessed by the original user. For example, if the types of item possessed by the original user are a red casual dress and a red Chinese dress, two types of options of “I'll go in a casual dress!” and “I'll go in a fancy dress!” In this case, for example, a message related to the type of item not possessed by the original user does not generate an option including a message, for example, “I'm going in a red suit!” As a result, accuracy of a plurality of options (a possibility of the original user selecting an option) can be increased. If the original user does not have a red item, an option such as “I'll' buy red clothes and go!” may be generated accordingly.

Additionally, for example, the option generator 262 may generate an option for transmitting the status according to the status of the original user. For example, if the original user is on the verge of going to bed, the option generator 262 may generate an option including a message “good night.” Furthermore, if the original user is on the move, the option generator 262 may generate an option including a message “When I get home, I will contact you.” Whether or not the user is moving may be determined based on sensor information from an acceleration sensor or a position sensor (for example, a position sensor based on a GPS receiver) that may be built into the terminal device 20.

Additionally, for example, the option generator 262 may change how to express a message (such as wording and the like) included in the option according to the relationship between the original user and the sending-side user (the other user that has sent the sent content related to the option of this time). For example, if the sending-side user is a work client, an option with a politely worded message is generated, and if the sending-side user is a contemporary of the original user, an option with a more casual message may be generated.

In addition, the option generator 262 may change (i) the option itself, (ii) how to express a message (such as wording and the like) included in the option, or the like according to a theme of an ongoing chat, members of the chat, or the like.

The option generator 262 may perform machine learning based on option information (performance data) selected by the original user from among the presented plurality of options. At this time, machine learning may be performed on the relationship between the option selected by the original user and the value of each parameter associated with the original user at the time of the selection. In this case, it is possible to present options that match the original user's preferences and selection tendencies. Also, by learning the trend and the like of the device in use for each time period, the accuracy of a plurality of options (a possibility of the original user selecting an option) can be increased.

Additionally, the option generator 262 may generate a stamp associated with an option, using an avatar associated with the original user. At this time, depending on the clothes of the avatar associated with the original user, even if the stamp has the same content, an avatar with different clothes may be represented.

In this manner, according to this embodiment, the option generator 262 can generate an option that has a high possibility of being selected by the original user. Thus, in addition to being able to reduce the load of manually inputting response contents corresponding to an option, it is also possible to reduce the user load of searching for a desired option via the terminal device 20. For example, in a situation in which the original user is using a smartphone, by providing options, the original user is released from the burden of searching for a desired stamp or entering text on a relatively small screen such as a smartphone. As a result, the original user can quickly make a desired reply during the chat. Also, for example, in a situation in which the original user is using a head-mounted display, the original user is released from the burden of typing on a virtual keyboard using a controller. As a result, the original user can quickly make a desired reply during the chat. In this embodiment, the number of options that are generated at one time by the option generator 262 may be changed according to the type of the terminal device 20 that is output. For example, in a situation in which the original user is using a terminal device 20 having a relatively small screen, such as a smartphone, the number of options generated at one time by the option generator 262 may be relatively small.

The item determination portion 264 determines whether the original user has a predetermined item when a response based on the moving type option is made by the original user. The predetermined item may be an item that satisfies a predetermined condition, from among items that can be attached to the avatar. The predetermined condition may be set based on the sent content that has been acquired by the sent content acquisition portion 261. For example, as in the above example, when the sent content is “Would you like to go to location A? The dress code is red clothes.,” the item that satisfies a predetermined condition may be set to “red clothes” or the like. Also, if the sent content is “Would you like to go to location A now? Today's color is red.,” the item that satisfies a predetermined condition may be set to “an arbitrary item that has a red color” or the like.

Also, when a response based on a moving type option is made by the user and the moving type option includes the device to be used, the item determination portion 264 determines whether the user has started using the terminal device 20 corresponding to the device to be used. For example, if the moving type option related to the response includes “I'll go by HMD!,” the item determination portion 264 determines whether the user is using a head-mounted display. In this case, the item determination portion 264 may determine the device to be used based on information from the server device 10.

When one of the plurality of options described above is selected based on the user's input, the response processor 266 may respond based on the one option and execute subsequent processing according to the one option. The subsequent processing may be determined according to the one option, depending on an attribute of the one option (for example, the above-mentioned direct response type, indirect response type, or the like). For example, different subsequent processing may be executed depending on whether the one option is an option associated with the predetermined flag value “0,” or the one option is an option associated with the predetermined flag value “1.” In the case of an option associated with the predetermined flag value “1” (an option that makes sense as a response to the sent content), some subsequent processing may be performed (for example, processing for transitioning the avatar associated with the original user, processing for adding the avatar related to the original user to a chat participant list, or the like). On the other hand, in the case of an option associated with the predetermined flag value “0” (an option that does not make sense as a response to the sent content), subsequent processing may not be executed.

For example, if a response based on the above-mentioned moving type option is made based on input by the original user, the response processor 266 executes movement-related processing according to the response. Movement-related processing is as described above. For example, if the moving type option related to the response by the user includes “I'll go by HMD!,” the response processor 266 may execute the movement-related processing if the use of the head-mounted display is detected by the item determination portion 264. This eliminates the need for operations such as selection of a destination after the user wears the head-mounted display, and allows the user to smoothly move as desired. In addition, by automatically moving to the meeting place in the metaverse space by selecting an option, it is possible to reduce the need to move around with the head-mounted display attached, and reduce a burden on the user such as VR motion sickness.

Furthermore, in a constant connection mode, the response processor 266 may automatically determine an option regarding reply content to the sent content, or automatically make a response that is based on the option (an example of a second response). The constant connection mode is a mode in which the above-described constant connection state is formed. A plurality of modes other than the constant connection mode may be set as operation modes. The constant connection mode may be formed according to an input from the original user, or may be automatically formed according to the original user's status. In the latter case, the constant connection mode may be automatically formed when the user is in a predetermined status (state), such as when the user is sleeping or eating.

Also, the response processor 266 may realize a function of notifying other users of the status of the original user in the constant connection mode. For example, when there is a change in the user's status or state, the response processor 266 may automatically make a response to that effect. Specifically, when the original user changes to wearing a head-mounted display, a message, a stamp, or the like indicating such change may be posted to a chat room associated with the constant connection mode. Such an automatic response to the status change may be performed when a response based on a moving type option is made. In this case, it is possible to automatically inform other users who care about the status of the original user (for example, various statuses related to whether the original user will soon arrive at the meeting place, and the like). As a result, it is possible to streamline the input and communication for each user's interaction related to appointments and the like, and reduce the processing load.

The support processor 268 supports or realizes attaching or acquiring a predetermined item related to a moving type option when the original user makes a response based on the moving type option. For example, when the item determination portion 264 determines that the original user possesses a predetermined item, the support processor 268 may automatically attach the predetermined item to the avatar related to the original user or may present a plurality of predetermined items that can be attached, such that the original user can select from among them. Additionally, if the item determination portion 264 determines that the user does not possess the predetermined item, the support processor 268 may generate a link that enables movement to a location at which the predetermined item can be procured (acquired), or may realize automatic movement to the location.

The original-user information memory 270 stores information regarding the original user among the information regarding each user stored in the user information memory 142 of the server device 10 described above. The terminal device 20 may store, for example, part of the information regarding other users in a friend relationship in addition to information regarding the original user.

The possessed item memory 272 stores information representing an item(s) possessed by the user. The item(s) may include an item (for example, clothes, shoes, and the like) that can be attached to the original user's avatar and an item(s) that can change the appearance of the avatar.

Although various embodiments have been described in detail above, it is not limited to a specific embodiment, and various modifications and changes are possible within the scope of the claims. It is also possible to combine all or a plurality of structural elements of the above-described embodiments.

### EXPLANATION OF SYMBOLS

1 chat-related support system
3 network
10 server device
11 server communicator
12 server memory
13 server controller
20 terminal devices
21 terminal communicator
22 terminal memory
23 display portion
24 input portion
25 terminal controller
142 user information memory
144 avatar information memory
150 user input acquisition portion
152 avatar processor
156 drawing processor
260 operation input acquisition portion
261 sent content acquisition portion
262 option generator
264 item determination portion
266 response processor
268 support processor
270 original-user information memory
272 possessed item memory

1. An information processing system that performs information processing related to chat-type communication among a plurality of users, the information processing system comprising:
one or more processors programmed to
acquire sent content that is sent from a first user in a chat, and
generate a plurality of options related to reply content from a second user with respect to the sent content, wherein
the plurality of options includes a first option associated with a destination in a virtual space displayed via an electronic device of the second user, and
the destination is determined based on the sent content.

2. The information processing system according to claim 1, wherein
the one or more processors are further programmed to, when a first response based on the first option is made, automatically execute movement-related processing to the destination associated with the first option, and
the movement-related processing includes at least one of (i) processing that causes movement to the destination in the virtual space and (ii) processing that outputs a display that enables movement to the destination in the virtual space.

3. The information processing system according to claim 2, wherein
the one or more processors generate a link to the destination.

4. The information processing system according to claim 3, wherein
the one or more processors generate the link according to a type of the electronic device from among a plurality of types of electronic devices.

5. The information processing system according to claim 1, wherein
a plurality of the first options is generated with respect to the sent content, and
at least one of the plurality of the first options is generated based on at least one of first parameters from among (i) the electronic device of the second user, (ii) an item in the virtual space possessed by the second user, (iii) a status of the second user, and (iv) a relationship between the second user and the first user.

6. The information processing system according to claim 2, wherein
the first option includes a message, a text, a symbol, or an image representing or suggesting a first electronic device type configured to be connected to a network, and
the one or more processors further
determine whether the first electronic device type has been used, when the first response based on the first option is made, and
execute the movement-related processing when it is determined that the first electronic device type has been used.

7. The information processing system according to claim 6, wherein
the image includes a stamp of the chat.

8. The information processing system according to claim 1, wherein
the plurality of options includes (i) the first option which accompanies a change in status of the second user and (ii) a second option which does not accompany the change in status of the second user.

9. The information processing system according to claim 1, wherein
the plurality of options includes (i) a third option associated with a first value of a second parameter and (ii) a fourth option associated with a second value of the second parameter different from the first value.

10. The information processing system according to claim 1, wherein
the one or more processors are further programmed to, when a first response based on the first option is made, acquire a predetermined item associated with the first option or attach the predetermined item to an avatar in the virtual space.

11. The information processing system according to claim 10, wherein
the one or more processors are further programmed to execute movement-related processing to the destination associated with the first option for which the first response is made when attachment or acquisition of the predetermined item is realized, and
the movement-related processing includes at least one of (i) processing that causes movement to the destination in the virtual space and (ii) processing that outputs a display that enables movement to the destination in the virtual space.

12. The information processing system according to claim 10, wherein
the predetermined item is determined based on the sent content.

13. The information processing system according to claim 2, wherein
the electronic device of the second user has a constant connection mode that maintains a state of being connected to a network, and
during the constant connection mode, the one or more processors automatically determine a second option related to the reply content with respect to the sent content, and automatically make a second response based on the second option.

14. The information processing system according to claim 13, wherein
during the constant connection mode, the one or more processors automatically make the second response when the second user is in a predetermined state.

15. An information processing apparatus that performs information processing related to chat-type communication among a plurality of users, the information processing apparatus comprising:
a processor programmed to
acquire sent content that is sent from a first user in a chat, and
generate a plurality of options related to reply content from a second user with respect to the sent content, wherein
the plurality of options includes a first option associated with a destination in a virtual space displayed via an electronic device of the second user, and
the destination is determined based on the sent content.

16. An information processing method related to chat-style communication among a plurality of users, the method comprising:
acquiring sent content that is sent from a first user in a chat; and
generating a plurality of options related to reply content from a second user with respect to the sent content, wherein
the plurality of options includes a first option associated with a destination in a virtual space displayed via an electronic device of the second user, and
the destination is determined based on the sent content.
